(19) United States
(12) Patent Application Publication
(10) Pub. No.: US 2009/0067856 A1
(43) Pub. Date: Mar. 12, 2009

(54) Image Forming Apparatus

(75) Inventor: Shinichi ITO, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,433

(22) Filed: Sep. 9, 2008

Related U.S. Application Data
(60) Provisional application No. 60/971,245, filed on Sep. 10, 2007.

(51) Int. Cl. G03G 21/00

(52) U.S. Cl. 399/34

(57) ABSTRACT

An embodiment according to the invention is characterized in that a waste toner is delivered to a certain place through a rotation of a stirring member (a paddle) for causing the waste toner to be even and the waste toner thus delivered is detected by means of detecting unit (an optical sensor).

### CROSS-REFERENCE TO RELATED APPLICATION

This application is based upon and claims the benefit of priority from: U.S. Provisional Application No. 60/971,245 filed on Sep. 10, 2007, the entire contents of each of which are incorporated herein reference.

### TECHNICAL FIELD

The present invention relates to an image forming apparatus capable of obtaining a copy image or print out of an object.

### BACKGROUND

For an image forming apparatus capable of using, as a recording material (a sheet material), a general plain paper which is not subjected to a special processing, image forming apparatuses utilizing various methods such as an electrophotographing method, an ink jet method and a thermal transfer method already spread widely. The image forming apparatus is changed to be multifunctional in accordance with a diversification of a request given from a user, and is currently referred to as a Multi-Functional peripheral (MFP).

In the MFP using the electrophotographing method, a latent image is visualized through a visualizing material which is referred to as a toner. In the electrophotographing method, the toner is selectively positioned on an output medium.

A part of the toner remains on a latent image holding member (without the transfer). A collecting mechanism collects the toner remaining on the latent image holding member. A housing container stores the toner collected by the collecting mechanism.

For example, JP-A-2003-148884 describes an example in which (a sensor) detects that a housing container is filled with the collected toner. The publication describes that a delivering member having a spiral blade delivers the waste toner from both ends in a longitudinal direction of a boxy body to a center. In the publication, the sensor for detecting the fill-up is positioned in the vicinity of a delivery termination for the waste toner and a collecting port having a maximum amount of collection.

In some cases, however, the sensor detects the fill-up before the housing container is filled with the toner.

### SUMMARY

The invention provides an image forming apparatus comprising: a photoconductor which holds a latent image; a developing device which supplies a toner to the latent image to carry out a development; a collector which collects the toner from the photoconductor; a housing which stores the toner collected by the collector; an auger which collects the toner into a predetermined position in the housing; and a detector, non-contact with the housing, which detects that the toner collected by the collector is present in a predetermined amount or more in the housing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an example of an imaging forming apparatus (a Multi-Functional Peripheral (MFP)) to which an embodiment of the invention is applied;

FIG. 2 is a view showing a toner collecting mechanism and a housing section in the MFP illustrated in FIG. 1;

FIG. 3 is a view showing the housing section illustrated in FIG. 2;

FIG. 4 is a view showing the housing section illustrated in FIG. 2;

FIG. 5 is a partial sectional view showing the housing section illustrated in FIG. 4;

FIG. 6 is a view showing an example of a paddle of the housing section illustrated in FIG. 2 and a toner sensor; and

FIG. 7 is a diagram schematically showing a control system of the MFP illustrated in FIGS. 1 to 6.

### DETAILED DESCRIPTION

An example of an embodiment according to the invention will be described below in detail with reference to the drawings.

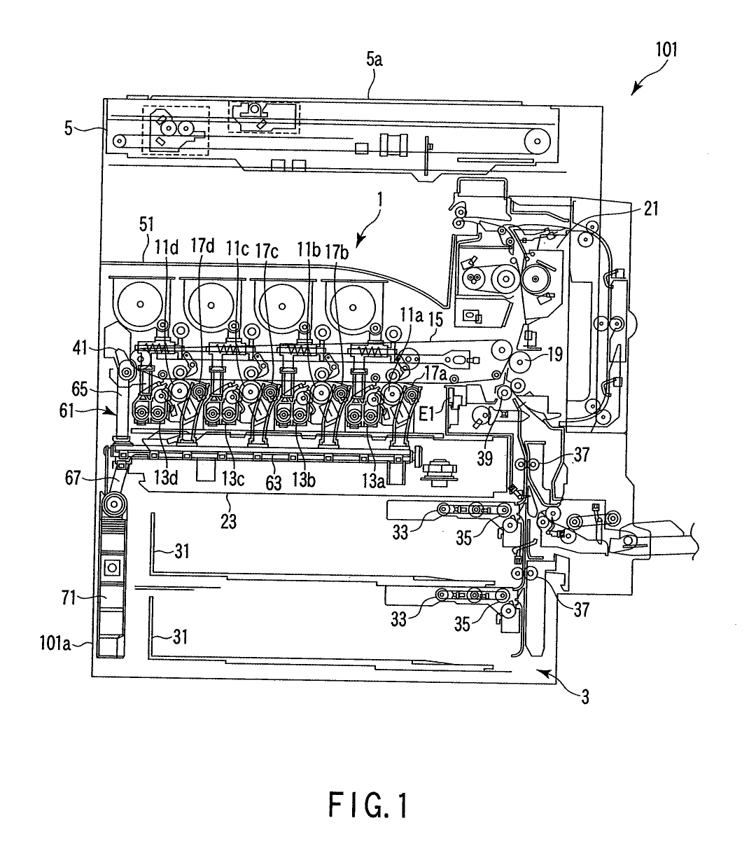

FIG. 1 schematically shows an image forming apparatus (MFP, Multi-Functional Peripheral) to which the invention can be applied.

An image forming apparatus 101 shown in FIG. 1 has an image forming section body 1 for outputting image information as an output image which is referred to as a hard copy or a print out, for example, a paper supplying section 3 capable of supplying, to the image forming section body 1, a paper (an output medium) having an optional size which is used for an image output, and an image reading section 5 for fetching, as image data, image information to be an image forming object in the image forming section body 1 from a object holding the image information (which will be hereinafter referred to as an original). The image reading section 5 includes an original table (an original glass) 5a for supporting an object and an image sensor for converting the image information into image data, for example, a CCD sensor, which will not be described in detail. The image reading section 5 converts a reflected light into an image signal through the CCD sensor. The reflected light is obtained by irradiating a light from an illuminating apparatus (not shown) onto the original set into the original table 5a.

An instruction input section for giving an instruction for starting an image formation in the image forming section body 1 and starting to read image information of the original through the image reading section 5, that is, a control panel (operating section) 9 is placed in a predetermined position of the image forming apparatus 101 which cannot be seen in FIG. 1.

The image forming section body 1 includes first to fourth photoconductive drums 11a to 11d for holding latent images, developing devices 13a to 13d for supplying a developer, that is, a toner to the latent images held by the photoconductive drums 11a to 11d and carrying out a development, a transfer belt 15 for holding toner images held by the photoconductive drums 11a to 11d in order, cleaners 17a to 17d for removing the toner remaining on the photoconductive drums 11a to 11d from the individual photoconductive drums 11a to 11d, a transfer device 19 for transferring the toner image held by the transfer belt 15 onto a plain paper or a sheet-like transfer medium (hereinafter referred to as a sheet material) such as an OHP sheet to be a transparent resin sheet, a fuser unit 21 for fixing the toner image transferred to the sheet material by the transfer device 19 onto the sheet material, and an exposing device 23 for forming latent images on the photoconductive drums 11a to 11d and the like.

The first to fourth developing devices 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developing devices 13a to 13d in order (of the formation of the toner images).

The paper supply section 3 supplies, in a predetermined timing, the sheet material to be used for transferring the toner image by the transfer device 19.

Cassettes, which will not be described in detail, positioned in a plurality of cassette slots 31 store sheet materials having optional sizes. Depending on an image forming operation which will not be described in detail, a pickup roller 33 takes the sheet material out of the corresponding cassette. The size of the sheet material corresponds to a size of the image of the developer formed by the image forming section body 1.

A separating mechanism 35 prevents at least two sheet materials from being taken out of the cassette by the pickup roller 33.

A plurality of delivery rollers 37 feed the sheet material separated to be one sheet by the separating mechanism 35 toward an aligning roller 39.

The aligning roller 39 feeds the sheet material to a transfer position in which the transfer device 19 and the transfer belt 15 come in contact with each other in a timing for transferring the image of the developer from the transfer belt 15 by the transfer device 19.

The fuser unit 21 fixes the image of the developer (toner) corresponding to the image information onto the sheet material, that is, the output image (hard copy, print out) and feeds the output image to a stock section 51 positioned in a space between the image reading section 5 and the image forming section body 1.

The transfer belt 15 holds the toner remaining on the transfer belt 15 (which will be hereinafter referred to as a waste toner) and a belt surface is moved. A belt cleaner 41 coming in contact with the transfer belt 15 in a predetermined position removes, from the transfer belt 15, the waste toner held on the belt surface of the transfer belt 15.

A housing container 71 is positioned between a side of the slot 31 and a frame rigid body 101a of the image forming apparatus 101.

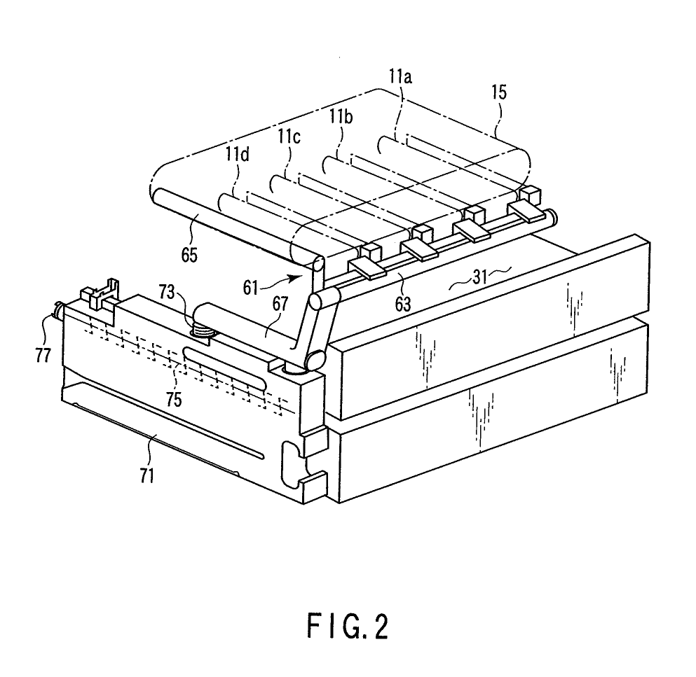

FIG. 2 shows a positional relationship between a waste toner delivering mechanism and the housing container.

A waste toner delivering mechanism 61 feeds, to the housing container 71, the waste toner removed from the photoconductive drums 11a to 11d by the cleaners 17a to 17d and the waste toner removed by the belt cleaner 41, which are described above. The waste toner delivering mechanism 61 includes a first waste toner delivering section 63 for feeding the waste toner removed by the belt cleaner 41 to the housing container 71 and a second waste toner delivering section 65 for feeding the waste toner removed by the cleaners 17a to 17d to the housing container 71, which will not be described in detail.

A relay delivering section 67 is positioned between the housing container 71 and the first and second waste toner delivering sections 63 and 65. The relay delivering section 67 connects the first and second waste toner delivering sections 63 and 65 to an almost central housing port 73 in a longitudinal direction of the housing container 71.

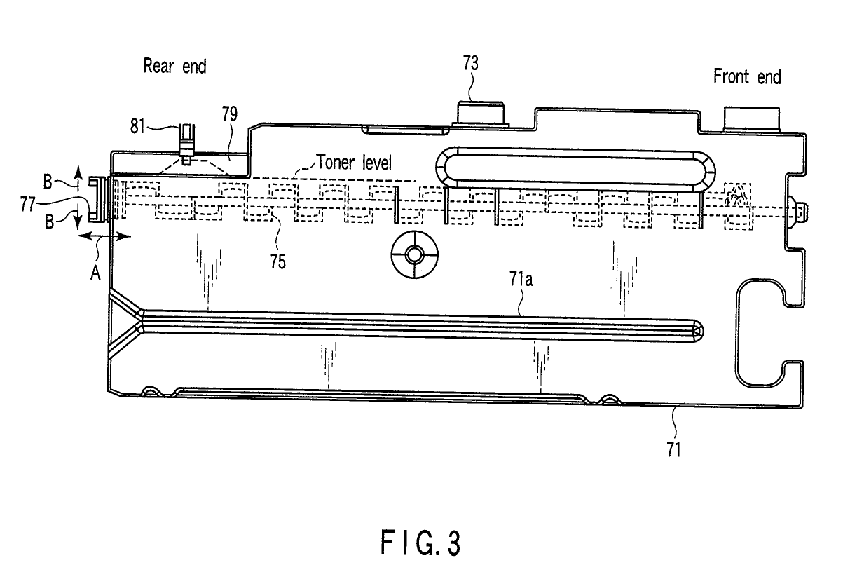

FIG. 3 shows an example of the housing container.

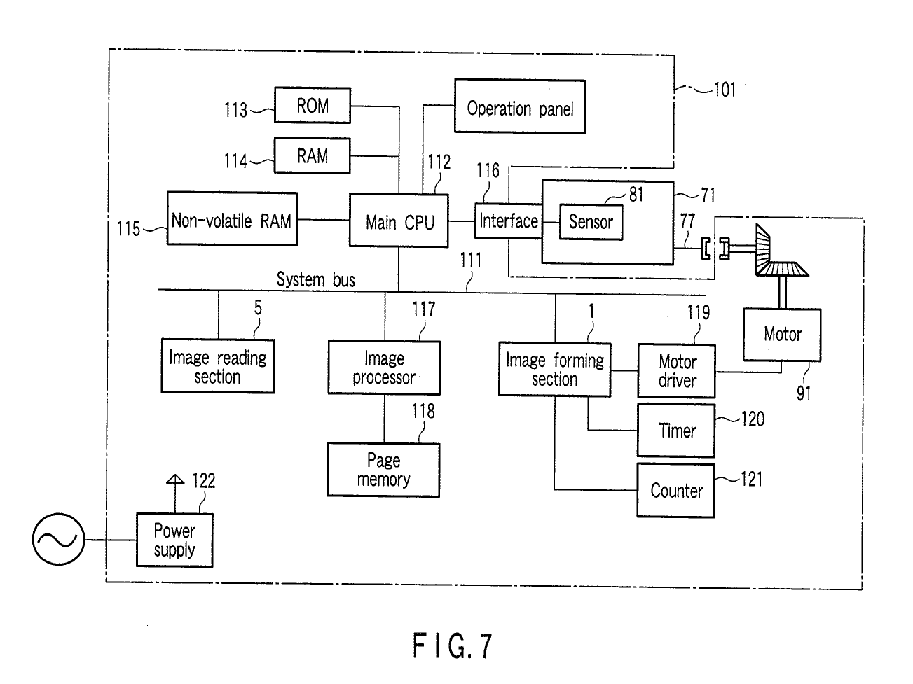

The housing container 71 includes a paddle 75 stirs the waste toner in the housing container 71 and collects a part of the waste toner into a predetermined position in the housing container 71. The paddle 75 has a coupling 77 for receiving a rotating force from an outside at one end in the longitudinal direction of the housing container 71. The coupling 77 is rotated through a rotation of a shaft of a motor 91 shown in FIG. 7 (which is connected to the coupling 77). The motor 91 is placed in a predetermined position on a back side of the image forming apparatus 101 (not shown). The coupling 77 has a looseness in an axial direction shown in an arrow A which serves to easily carry out coupling to the shaft of the motor 91. The coupling 77 also has a looseness in an orthogonal direction to a shaft shown in an arrow B which serves to easily carry out coupling to the shaft of the motor 91.

The housing container 71 has a guide section (a rib or a groove) 71a for guiding a movement from a front side of the image forming apparatus 101.

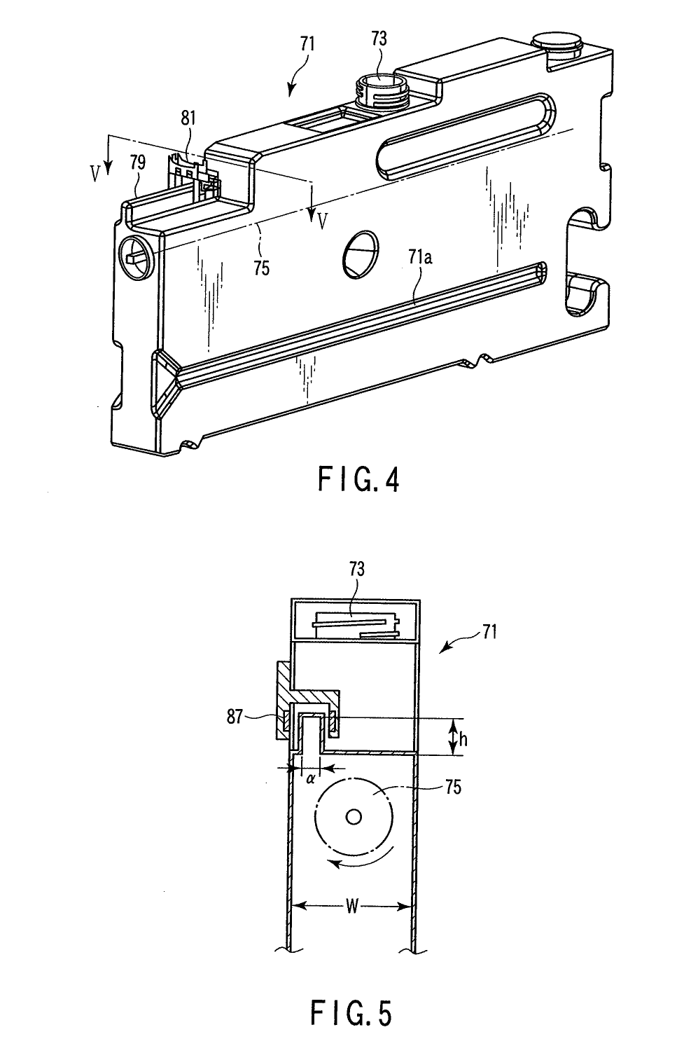

FIGS. 4 and 5 show a positional relationship between the housing container and the toner sensor.

The housing container 71 has a fill-up detecting region 79 for permitting a toner sensor 81 to detect (a level of) the waste toner when (the housing container 71 is filled with the waste toner). The fill-up detecting region 79 is positioned above an outer periphery of a rotating circle of the paddle 75 of the housing container 71 by 20 mm or more, for example, (an upper limit of 30 mm) and is (a space) having a smaller width d than a width W of the housing container 71. d and W are approximately ⅓ to ⅕. A depth (an inside height) h is equal to the width d or reaches a position corresponding to the position provided above the outer periphery of the rotating circle of the paddle 75 by 20 mm or more, for example (the upper limit of 30 mm). As an example, the housing container 71 has a size of approximately 200 to 300 mm in a vertical direction, 400 to 500 mm in a longitudinal direction and 40 mm in a transverse direction.

The fill-up detecting region 79 permits a toner sensor 81 to continuously detect (a presence of) the waste toner accumulated in the housing container 71 for a predetermined time.

The fill-up detecting region 79 is positioned close to the back face of the image forming apparatus 101.

The toner sensor 81 detects that the waste toner is filled in the housing container 71 in a predetermined position on the outside of the housing container 71. The toner sensor 81 is of a well-known optical type in which a light transmitting section (a light source) and a light receiving section (a photodetector) are provided at a predetermined interval. The toner sensor 81 may serve to detect an electrostatic capacity.

The toner sensor 81 is placed in a position in which the housing container 71 can be attached from the front side of the image forming apparatus 101. The toner sensor 81 permits the housing container 71 to be moved to the front side of the apparatus 101. The fill-up detecting region 79 is placed in a position in which the housing container 71 can be attached from the front side of the image forming apparatus 101 without hindering the toner sensor 81 from being operated.

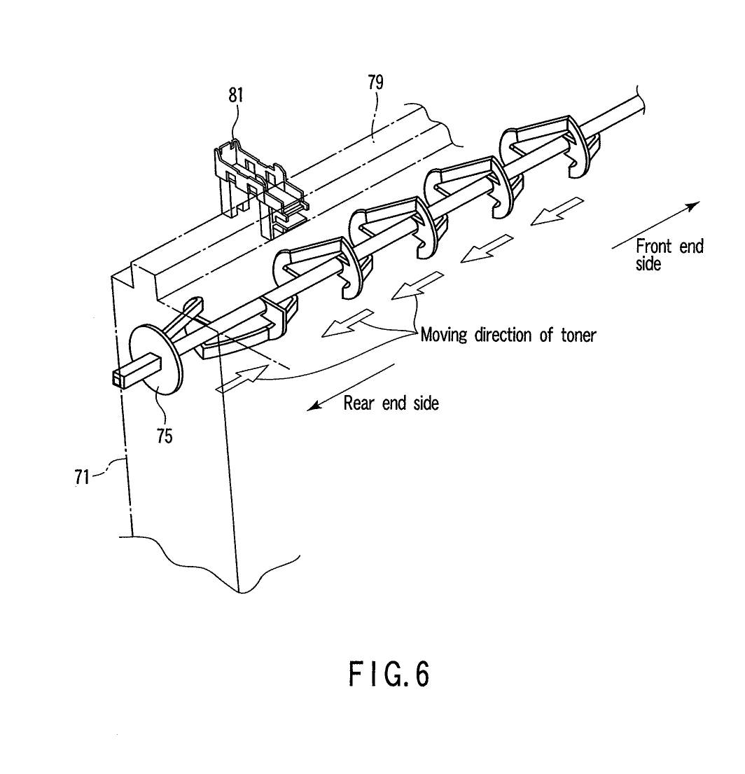

FIG. 6 shows an example of the paddle for the housing container.

The paddle 75 has a plurality of blade members taking a predetermined shape which provides a delivery force for delivering the toner in one direction. Each of the blade members of the paddle 75 wholly has such a shape as to deliver the waste toner to the back side of the image forming apparatus 101 (in an assembling state). The closest blade member to the back face has such a shape as to deliver the waste toner to the front side of the image forming apparatus 101. The paddle 75 collects the waste toner more greatly in a predetermined position which is close to the back face of the housing container 71 as compared with other positions in the longitudinal direction. The paddle 75 increases a density of the waste toner which corresponds to a position in which the toner sensor 81 detects the waste toner. The paddle 75 increases the accumulation height (volume) of the waste toner which corresponds to a position in which the toner sensor 81 detects the waste toner. An axis of the paddle 75 is offset from a center in a transverse direction of the fill-up detecting region 79. An opening section of the fill-up detecting region 79 is opposed to a rotating direction of the paddle 75.

FIG. 7 shows elements for controlling a rotation of the paddle for the housing container.

The image forming apparatus (MFP) 101 includes a system bus line 111. The system bus line 111 connects a main control block, that is, a main CPU 112 for processing image information of an object to be outputted by an image forming section 1 including a scanner (image reading section) 5 and an image processor 117, and the image forming section 1. The main control block 112 connects an ROM (Read Only Memory) 113, an RAM (Random Access Memory) 114, and a Non-volatile RAM 115 for storing a total rotating number or a total rotating time of the motor 91, the number of image forming operations, a total operating (working) time or the like, an interface 116 for giving an instruction of an output of the toner sensor 81 to the main control block 112, and an operation panel. The image processor 117 connects a page memory 118. The image forming section 1 connects a motor driver 119 for rotating the motor 91, a timer 120 for counting a time required for connecting a commercial power to a power supply 122, and a counter 121 for counting the number of the image forming operations of the image forming section 1 (the number of the outputs of the print out).

The motor 91 does not rotate until the number of image forming operations, that is, a count value of the counter 121 reaches a certain value, for example. More specifically, the motor 91 can also compensate for the influence of JAM. Some count values are varied in accordance with the size of the paper (sheet material). The count value of A3 is a double of that of A4.

The motor 91 does not rotate until the number of image outputs, that is, the count value of the counter 121 reaches a certain value, for example.

The motor 91 rotates for a certain period every predetermined time when the image formation (the number of the outputs of the print out, that is, the count value of the counter 121) exceeds the certain value.

The motor 91 rotates for a predetermined period when a power supply of the image forming apparatus 101 is turned ON (the power supply 122 connects the commercial power). The motor 91 rotates for a certain time every predetermined period based on the timing of the timer 120, for example.

The motor 91 rotates while the developing devices 13a to 13d operate.

The motor 91 rotates for a period in which the belt surface of the transfer belt 15 moves.

The motor 91 rotates while the transfer medium is delivered.

The image forming apparatus according to the embodiment of the invention prevents the detection of the fill-up before the container for storing the waste toner is filled up.

Moreover, the container of the image forming apparatus according to the embodiment of the invention is reliably filled with the waste toner. Therefore, the container substantially prevents the necessity of an exchange for a life cycle in which the developing device and the photoconductive drum need to be exchanged.

Furthermore, the image forming apparatus according to the embodiment of the invention reduces an exchange frequency of the waste toner housing container. Therefore, a running cost can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a photoconductor which holds a latent image;
a developing device which supplies a toner to the latent image to carry out a development;
a collector which collects the toner from the photoconductor;
a housing which stores the toner collected by the collector;
an auger which collects the toner into a predetermined position in the housing; and
a detector, non-contact with the housing, which detects that the toner collected by the collector is present in a predetermined amount or more in the housing.

2. The apparatus of claim 1, wherein the auger partially increases a volume of the toner.

3. The apparatus of claim 2, wherein the auger includes a rotating shaft having a spiral blade, and a direction of the spiral blade being varied in a part in a longitudinal direction.

4. The apparatus of claim 2, wherein the detector is placed in a predetermined position above the auger.

5. The apparatus of claim 3, wherein the detector is placed in a predetermined position above the auger.

6. The apparatus of claim 1, further comprising:
a counter which sets a timing in which the auger rotates.

7. The apparatus of claim 6, wherein the counter counts the number of image forming operations.

8. The apparatus of claim 6, wherein the counter counts the number of outputs of print out.

9. The apparatus of claim 6, wherein the auger partially increases a volume of the toner.

10. The apparatus of claim 9, wherein the detector is placed in a predetermined position above the auger.

11. An image forming apparatus comprising:
means for holding a latent image;
means for supplying a toner to the latent image, thereby carrying out a development;
means for collecting a toner from the holding means;
means for storing the toner collected by the collecting means;
means for stirring to collect the toner in a predetermined position in the storing means; and
means, non-contact with the storing means, for detecting that the toner collected by the collecting means is present in a predetermined amount or more in the storing means.

12. The apparatus of claim 11, wherein the stirring means partially increases a volume of the toner.

13. The apparatus of claim 12, wherein the stirring means includes a rotating shaft having a spiral blade and a direction of the spiral blade being varied in a part in a longitudinal direction.

14. The apparatus of claim 12, wherein the detector is placed in a predetermined position above the auger.

15. The apparatus of claim 13, wherein the detector is placed in a predetermined position above the auger.

16. The apparatus of claim 11, further comprising:
means for setting a timing in which the auger rotates.

17. The apparatus of claim 16, wherein the setting means counts the number of image forming operations.

18. The apparatus of claim 16, wherein the setting means counts the number of outputs of print out.

19. The apparatus of claim 16, wherein the stirring means partially increases a volume of the toner.

20. The apparatus of claim 19, wherein the detecting means is placed in a predetermined position above the stirring means.

21. A toner housing container to be used for an image forming apparatus, comprising:
a main body storing a toner;
a roller member moving the toner in a predetermined direction and including spiral blades having different directions;
a couple member connecting an external thrust to the roller member; and
a detection member placed in a predetermined position from a rotating circle of the spiral blade of the roller member and serving to detect a level of the toner.

22. The housing container of claim 21, wherein the spiral blade has such a direction as to increase a volume of the toner in the main body in a specific position.

23. The housing container of claim 21, wherein the detection member comes in non-contact with the main body.

24. A method of detecting a stored toner, comprising:
moving a toner stored in a main body to a predetermined position by means of a roller member for being rotated by a thrust applied from a couple member and partially increasing a volume of the toner; and
detecting a level of the toner by means of a detection member placed in a predetermined position from a rotating circle of a spiral blade of the roller member.

25. The method of claim 24, wherein the detection member comes in non-contact with the main body.
